(19) United States
(12) Patent Application Publication
(10) Pub. No.: US 2026/0008271 A1
(43) Pub. Date: Jan. 8, 2026

(54) INK REPLENISHMENT CONTAINER

(71) Applicant: SEIKO EPSON CORPORATION, Tokyo (JP)

(72) Inventors: Yuta KOIKE, Matsumoto-shi (JP); Tadahiro MIZUTANI, Shiojiri-shi (JP); Tadashi WATANABE, Matsumoto-shi (JP); Atsushi KOBAYASHI, Matsumoto-shi (JP); Shun OYA, Kiso-machi (JP)

(73) Assignee: SEIKO EPSON CORPORATION, Tokyo (JP)

(21) Appl. No.: 19/249,575

(22) Filed: Jun. 25, 2025

(30) Foreign Application Priority Data
Jun. 26, 2024 (JP) 2024-102887

(51) Int. Cl. B41J 2/175

(52) U.S. Cl. CPC B41J 2/17596; B41J 2/17553

(57) ABSTRACT

An ink replenishment container includes a container main body, an ink outlet forming portion, and an outlet valve unit. The outlet valve unit includes a valve body, a spring member, and a seal member. The valve body includes a cylindrical portion, a seal surface, and a protrusion. The protrusion includes a partition contact portion and an inclined surface extending from the partition contact portion toward the seal surface. A cross-sectional area of the protrusion in a direction orthogonal to a central axis direction is larger on a side opposite from an outlet side than on the outlet side. An angle formed between the inclined surface and the seal surface is 110 degrees or more.

The present application is based on, and claims priority from JP Application Serial Number 2024-102887, filed Jun. 26, 2024, the disclosure of which is hereby incorporated by reference herein in its entirety.

### BACKGROUND

### 1. Technical Field

The present disclosure relates to a technique for an ink replenishment container.

### 2. Related Art

In the related art, a technique for replenishing an ink tank of a printer with ink from an ink replenishment container by gas-liquid exchange via an ink introduction member communicating with the ink tank of the printer is known (JP-A-2023-43905). In this technique, the ink replenishment container is provided with, at an ink outlet, a spring valve having a valve body and a spring member that biases the valve body. The printer is replenished with ink by inserting the ink introduction member from the ink outlet and pressing the valve body in a direction opposite to the biasing direction of the spring member to open the spring valve. The spring valve is closed by the ink introduction member being removed. The valve body has a protrusion that is in contact with the ink introduction member. The protrusion is formed such that the cross-sectional area on the opposite side from the ink outlet is larger than that on the ink outlet side. As a result, the protrusion has a sloped surface that expands outward from the ink outlet side toward the side opposite from the ink outlet.

As in the related art, the protrusion of the valve body has a sloped surface which expands outward from the ink outlet side toward the side opposite from the ink outlet, and the gas and the liquid thus flow along the sloped surface. Accordingly, the printer can be smoothly replenished with the ink by gas-liquid exchange. The present inventors have improved the ink replenishment container in order to further shorten the replenishment time of the ink and have reached the present disclosure.

### SUMMARY

(1) According to an aspect of the present disclosure, there is provided an ink replenishment container. The ink replenishment container that replenishes an ink tank of a printer with ink via an ink introduction member having a plurality of flow paths partitioned by a partition, the flow paths communicating with the ink tank, the ink replenishment container includes a container main body configured to accommodate ink, an ink outlet forming portion that is coupled to the container main body and includes a tubular portion that forms an outlet on a side opposite from the container main body, and an outlet valve unit that is mounted in the ink outlet forming portion, is opened by the ink introduction member being inserted into the tubular portion from the outlet, and is closed by the ink introduction member being removed from the tubular portion, in which the outlet valve unit includes a valve body that is movably disposed in a central axis direction along a central axis of the tubular portion, a spring member that biases the valve body toward the outlet side, and a seal member that is positioned on the outlet side with respect to the valve body in the central axis direction and includes a through-hole into and from which the ink introduction member is inserted and removed, the seal member further includes a first seal portion that closes the through-hole by being in contact with the valve body in a valve-closed state of the outlet valve unit, a gap is formed between the first seal portion and the valve body in a valve-open state of the outlet valve unit, the valve body includes a cylindrical portion extending in the central axis direction, a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and a protrusion that is formed on the outlet-side end surface on an inner side with respect to the seal surface in the radial direction, the protrusion includes a partition contact portion that is positioned on the outlet side with respect to the seal surface in the central axis direction and is in contact with the partition of the ink introduction member in the valve-open state, and an inclined surface extending from the partition contact portion toward the seal surface, a cross-sectional area of the protrusion in a direction orthogonal to the central axis direction is larger on the side opposite from the outlet than on the outlet side, and an angle formed between the inclined surface and the seal surface is 110 degrees or more.

(2) According to another aspect of the present disclosure, there is provided an ink replenishment container. The ink replenishment container that replenishes an ink tank of a printer with ink via an ink introduction member having a plurality of flow paths partitioned by a partition, the flow paths communicating with the ink tank, the ink replenishment container includes a container main body configured to accommodate ink, an ink outlet forming portion that is coupled to the container main body and includes a tubular portion that forms an outlet on a side opposite from the container main body, and an outlet valve unit that is mounted in the ink outlet forming portion, is opened by the ink introduction member being inserted into the tubular portion from the outlet, and is closed by the ink introduction member being removed from the tubular portion, in which the outlet valve unit includes a valve body that is movably disposed in a central axis direction along a central axis of the tubular portion, a spring member that biases the valve body toward the outlet side, and a seal member that is positioned on the outlet side with respect to the valve body in the central axis direction and includes a through-hole into and from which the ink introduction member is inserted and removed, the seal member further includes a first seal portion that closes the through-hole by being in contact with the valve body in a valve-closed state of the outlet valve unit, a gap is formed between the first seal portion and the valve body in a valve-open state of the outlet valve unit, the valve body includes a cylindrical portion extending in the central axis direction, a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and a protrusion that is formed on the outlet-side end surface on an inner side with respect to the seal surface in the radial direction, and the protrusion includes a partition contact portion that is positioned on the outlet side with respect to the seal surface in the central axis direction and is in contact with the partition of the ink introduction member in the valve-open state, and a closing portion that closes a part of an opening end surface of some of the plurality of flow paths of the ink introduction member having a uniform opening end area.

### BRIEF DESCRIPTION OF THE DRAWINGS

FIG. 1 is a perspective view of a printer.

FIG. 2 is a perspective view of an ink tank.

FIG. 3 is a perspective view illustrating a replenishment state.

FIG. 4 is an exploded perspective view of an ink replenishment container.

FIG. 5 is a partial sectional view of the ink replenishment container of a first embodiment in a non-replenishment state.

FIG. 6 is an enlarged view of a part of FIG. 5.

FIG. 7 is a partial sectional view of the ink replenishment container or the like according to the first embodiment in the replenishment state.

FIG. 8 is an enlarged view of a part of FIG. 7.

FIG. 9 is a perspective view of an outlet valve unit.

FIG. 10 is a view illustrating a configuration of a valve body according to the first embodiment.

FIG. 11 is a schematic view of the ink replenishment container or the like according to the first embodiment in the replenishment state.

FIG. 12 is a schematic view of an ink replenishment container or the like as a reference example in the replenishment state.

FIG. 13 is a partial sectional view of the ink replenishment container or the like in a transition state.

FIG. 14 is a partial sectional view of the ink replenishment container or the like as the reference example in the transition state.

FIG. 15 is a view illustrating a configuration of a valve body according to a second embodiment.

FIG. 16 is a partial sectional view of an ink replenishment container of the second embodiment in the non-replenishment state.

FIG. 17 is an enlarged view of a part of FIG. 16.

FIG. 18 is a partial sectional view of the ink replenishment container or the like according to the second embodiment in the replenishment state.

FIG. 19 is an enlarged view of a part of FIG. 18.

FIG. 20 is a view illustrating a contact state between a protrusion and a tip end surface of an ink introduction member.

### DESCRIPTION OF EMBODIMENTS

### A. First Embodiment

### A-1. Configuration of Printer

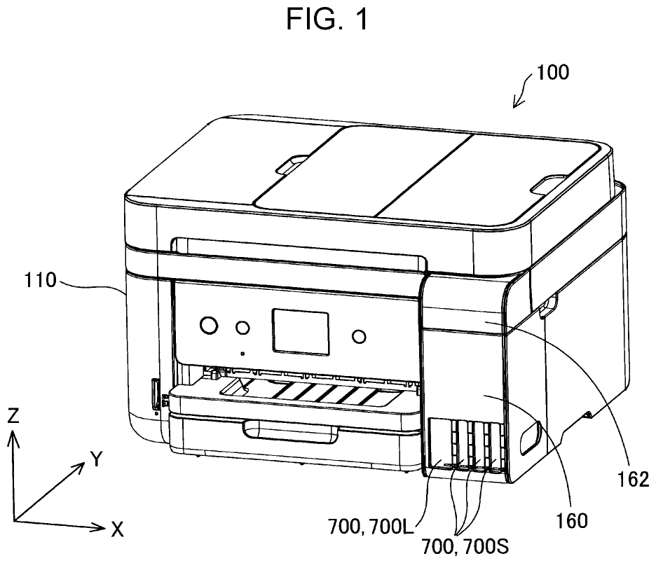

FIG. 1 is a perspective view of a printer 100. FIG. 1 illustrates XYZ axes that are three spatial axes orthogonal to each other. The directions in which arrows of the X-axis, the Y-axis, and the Z-axis are oriented indicate positive directions along the X-axis, the Y-axis, and the Z-axis, respectively. Positive directions along the X-axis, the Y-axis, and the Z-axis are defined as a +X direction, a +Y direction, and a +Z direction, respectively. Directions opposite to the directions in which arrows of the X-axis, the Y-axis, and the Z-axis are oriented are negative directions along the X-axis, the Y-axis, and the Z-axis, respectively. Negative directions along the X-axis, the Y-axis, and the Z-axis are defined as a −X direction, a −Y direction, and a −Z direction, respectively. The directions along the X axis, the Y axis, and the Z axis, regardless of positive or negative, are referred to as an X direction, a Y direction, and a Z direction, respectively.

In the present embodiment, in the use state of the printer 100, the X axis and the Y axis are axes along the horizontal plane, and the Z axis is an axis along the gravity direction. In the following, a gravity direction is a −Z direction, and an anti-gravity direction is a +Z direction. A direction from the rear surface side to the front surface side of the printer 100 is defined as a −Y direction, and a direction from the front surface side to the rear surface side is defined as a +Y direction. In addition, when the printer 100 is viewed from the front surface side, a direction from the right side to the left side is a −X direction, and a direction from the left side to the right side is a +X direction. The “use state of the printer 100” refers to a state where the printer 100 is installed on a horizontal plane. The same applies to the following drawings and descriptions.

The printer 100 is an ink jet printer that ejects ink onto a print medium for printing. The printer 100 includes a housing 110. A carriage (not illustrated) is provided inside the housing 110. The carriage is movable in the main scanning direction along the X direction. A print head (not illustrated) that ejects ink onto a print medium is installed on the carriage. An ink tank accommodating unit 160 is provided at one end of the front surface of the housing 110. The ink tank accommodating unit 160 accommodates a plurality of ink tanks 700S and 700L. The ink tank accommodating unit 160 has an openable and closable lid 162 on the upper portion thereof. The first ink tank 700S is a tank having a small capacity. The second ink tank 700L is a tank having a large capacity. Meanwhile, in the following description, both the ink tanks are simply referred to as an “ink tank 700” without distinction. The ink tank 700 is coupled to the print head of the carriage by a tube (not illustrated). That is, the ink tank 700 is a stationary ink tank that is not mounted on the carriage of the printer 100. The ink tank 700 may be mounted on the carriage of the printer 100.

### A-2. Configuration of Ink Tank

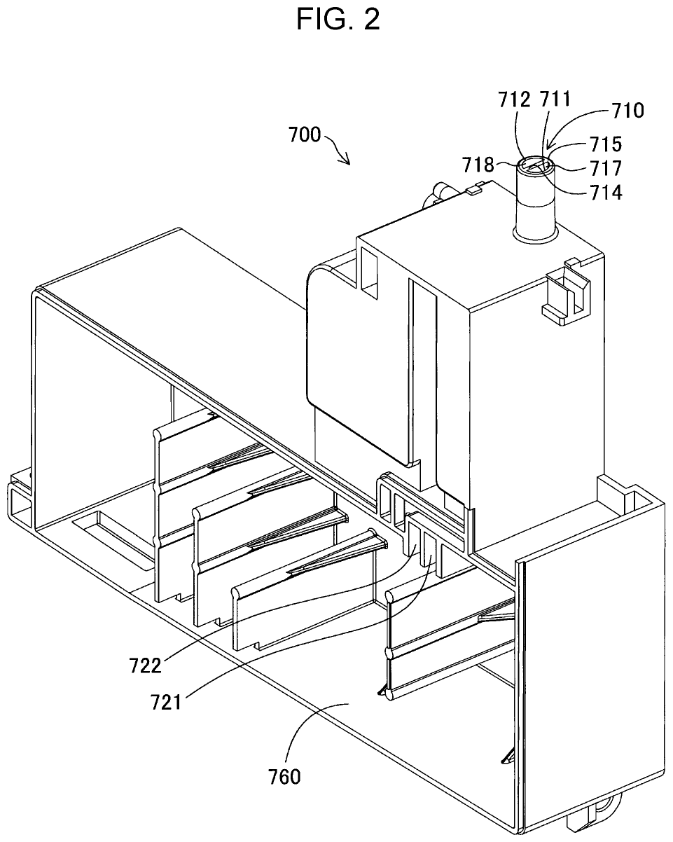

FIG. 2 is a perspective view of the ink tank 700. An ink introduction member 710 is provided on the upper surface of the ink tank 700. The ink introduction member 710 is a tubular member for replenishing the ink tank 700 with ink. The ink introduction member 710 protrudes upward from the ink tank 700. The ink introduction member 710 has a plurality of introduction flow paths 711 and 712 partitioned by a partition 714. In the present embodiment, the ink introduction member 710 has two introduction flow paths 711 and 712. The two introduction flow paths 711 and 712 communicate with two in-tank flow paths 721 and 722, respectively, protruding into an ink accommodating chamber 760 of the ink tank 700. The two introduction flow paths 711 and 712 have opening end surfaces 717 and 718, respectively, as an opening formed in a tip end surface 715 of the ink introduction member 710. An opening end area, which is an area of the opening end surfaces 717 and 718, is uniform between the two introduction flow paths 711 and 712. A part of the tip end surface 715 of the ink introduction member 710 corresponds to the end portion of the partition 714.

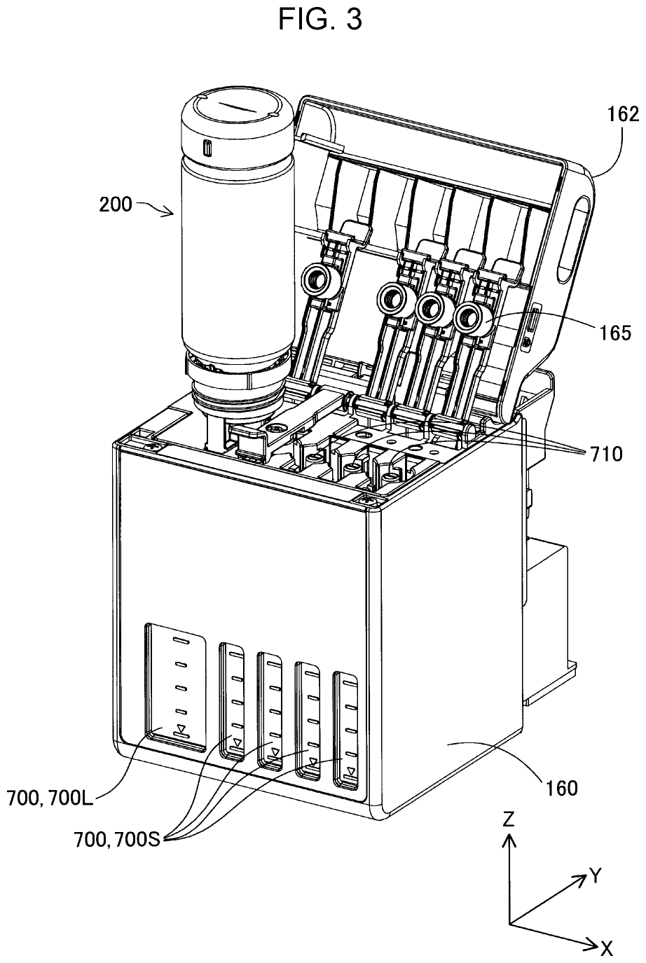

FIG. 3 is a perspective view illustrating a replenishment state where the ink tank 700 is replenished with the ink from an ink replenishment container 200. The front surface of the ink tank 700 is formed of a transparent member. As a result, the remaining amount of ink in the ink tank 700 can be visually recognized from the outside. When the remaining amount of ink in the ink tank 700 is reduced, the user can replenish the ink tank 700 with ink from the ink introduction member 710 by opening the lid 162. In the present disclosure, the “ink replenishment” means an operation of supplying ink to the ink tank 700 to increase the remaining amount of ink in the ink tank 700. Meanwhile, the ink tank 700 is not required to be filled up with ink according to the “ink replenishment”. The “ink replenishment” includes an operation of filling the empty ink tank 700 with ink when the printer 100 is used for the first time.

The ink tank accommodating unit 160 has a sealing cap 165 for sealing the tip end of the ink introduction member 710. When the ink tank 700 is not replenished with the ink, the tip end of the ink introduction member 710 is sealed with the sealing cap 165. When the ink tank 700 is replenished with the ink, the sealing cap 165 is removed from the ink introduction member 710, and the tip end portion of the ink replenishment container 200 is inserted into the position of the ink introduction member 710. As a result, the ink tank 700 is replenished with the ink.

### A-3. Configuration of Ink Replenishment Container

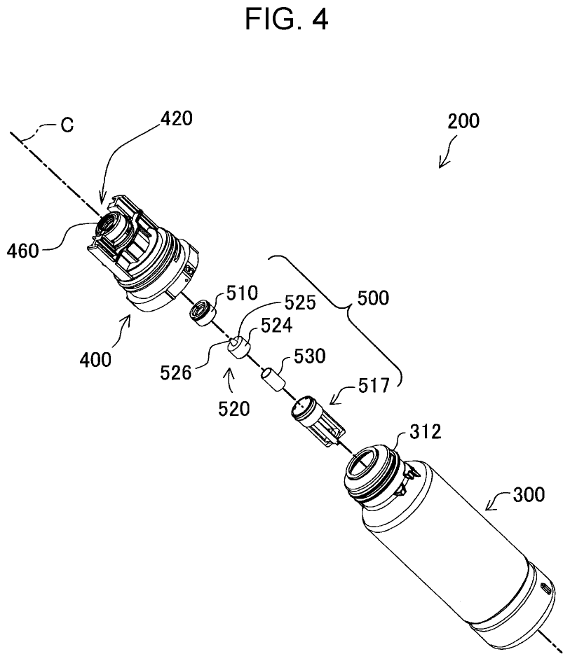

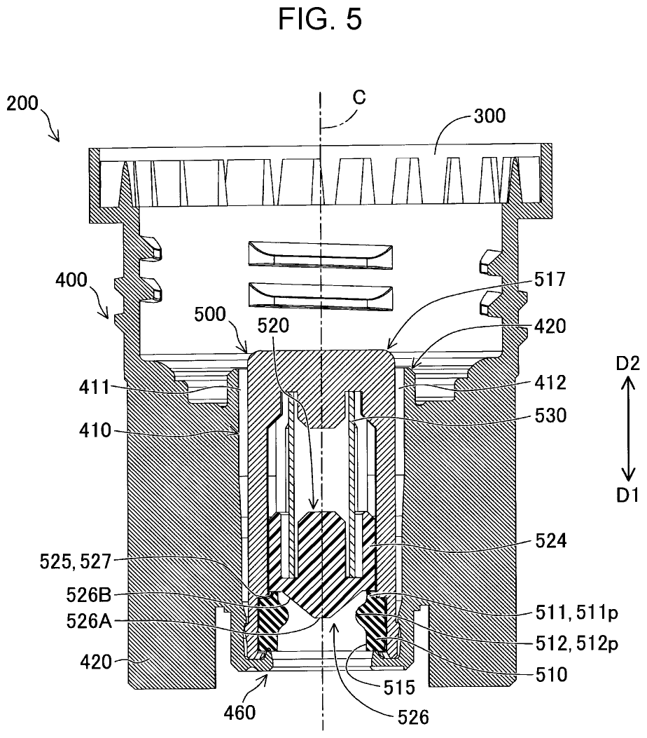

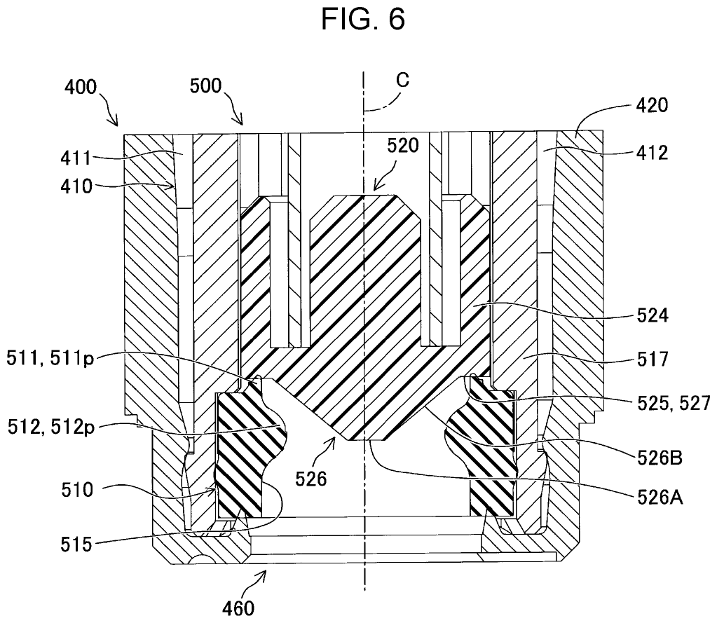

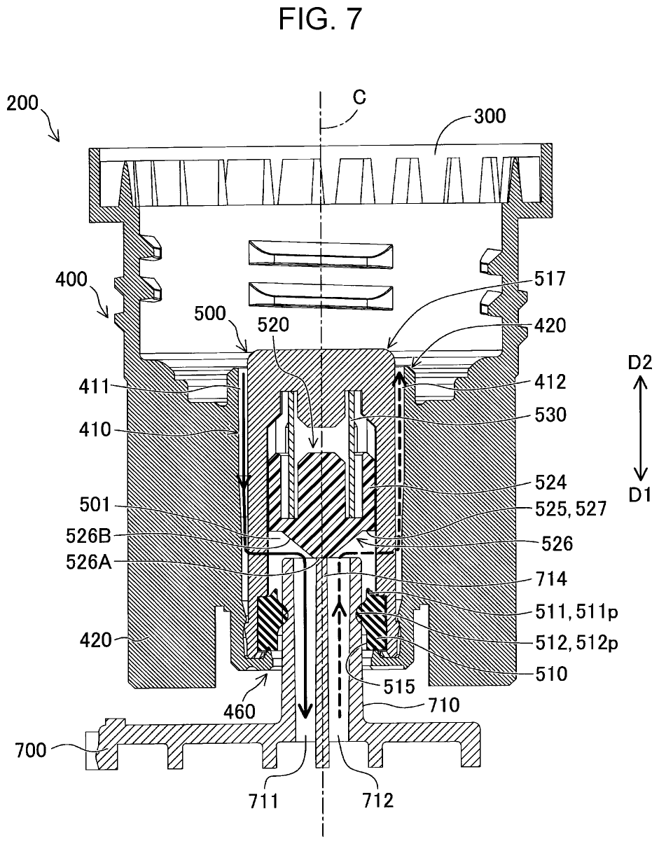

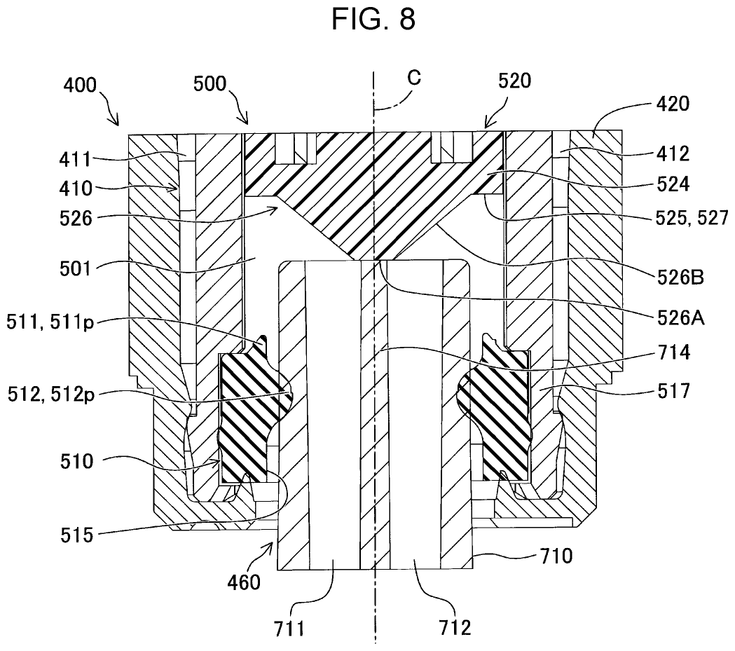

FIG. 4 is an exploded perspective view of the ink replenishment container 200. FIG. 5 is a partial sectional view of the ink replenishment container 200 of the first embodiment in a non-replenishment state in which the ink tank 700 is not replenished with the ink. FIG. 5 shows a cross section when a part of the configuration of the ink replenishment container 200 is cut along the central axis C of a tubular portion 420 which will be described later. FIG. 6 is an enlarged view of a part of FIG. 5. FIG. 7 is a partial sectional view of the ink replenishment container 200 and the ink tank 700 of the first embodiment in the replenishment state in which the ink tank 700 is replenished with ink. FIG. 7 shows a cross section when a part of the configuration of the ink replenishment container 200 and a part of the configuration of the ink introduction member 710 are cut along the central axis C of the tubular portion 420, which will be described later. FIG. 8 is an enlarged view of a part of FIG. 7.

The ink replenishment container 200 is a container for replenishing the ink tank 700 with ink by gas-liquid exchange. As illustrated in FIG. 4, the ink replenishment container 200 includes a container main body 300, an ink outlet forming portion 400, and an outlet valve unit 500.

The container main body 300 is configured to be capable of accommodating ink. The container main body 300 is a hollow cylindrical container having an opening. An outer screw 312 for mounting the ink outlet forming portion 400 is provided on the outer peripheral surface of the container main body 300 on the opening side.

The ink outlet forming portion 400 is coupled to the container main body 300. As illustrated in FIG. 7, the ink outlet forming portion 400 has the tubular portion 420 and a tubular flow path portion 410. The tubular portion 420 forms an ink outlet 460 on the side opposite from the container main body 300. The ink introduction member 710 is inserted into the tubular flow path portion 410 via a through-hole 515 of a seal member 510, which will be described later, of the outlet valve unit 500. The tubular flow path portion 410 has a plurality of replenishment flow paths 411 and 412. In the present embodiment, the tubular flow path portion 410 has two replenishment flow paths 411 and 412. Each of the two replenishment flow paths 411 and 412 is formed by a gap between the inner peripheral surface of the tubular portion 420 and the outer peripheral surface of the outlet valve unit 500. One of the two replenishment flow paths 411 and 412 is used as an ink flow path, and the other is used as an air flow path. In FIG. 7, the solid line arrows indicate the flow of the ink. The broken line arrows indicate the flow of air. In the present embodiment, the first replenishment flow path 411 is used as a flow path of the ink. The second replenishment flow path 412 is used as an air flow path.

The outlet valve unit 500 is mounted in the ink outlet forming portion 400. As illustrated in FIGS. 5 and 6, in the non-replenishment state, the outlet valve unit 500 is in a valve-closed state in which the ink outlet 460 is sealed so that the ink does not leak to the outside. As illustrated in FIGS. 7 and 8, in the replenishment state, the outlet valve unit 500 is in the valve-open state by releasing the sealing of the ink outlet forming portion 400 so that the ink flows into the ink introduction member 710. The outlet valve unit 500 is a spring valve. The outlet valve unit 500 is opened by inserting the ink introduction member 710 into the tubular portion 420 from the ink outlet 460. As a result, the replenishment flow paths 411 and 412 of the ink replenishment container 200 and the introduction flow paths 711 and 712 of the printer 100 respectively communicate with each other. As illustrated in FIGS. 5 and 6, the outlet valve unit 500 is closed by the ink introduction member 710 being removed from the tubular portion 420.

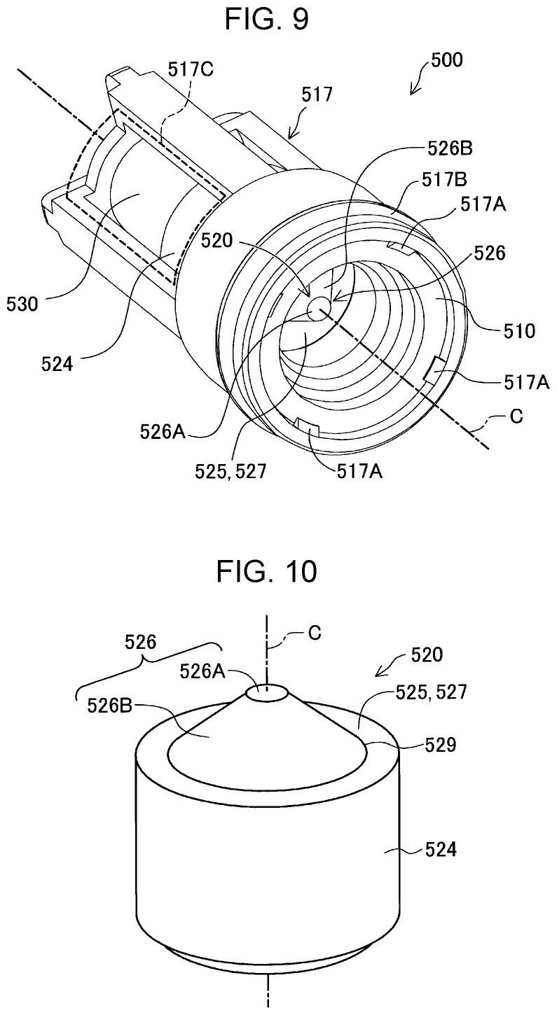

FIG. 9 is a perspective view of the outlet valve unit 500. The outlet valve unit 500 includes a valve housing 517, a valve body 520, a spring member 530, and the seal member 510 that functions as a valve seat.

The valve housing 517 accommodates the valve body 520, the spring member 530, and the seal member 510 inside. The shape of the valve housing 517 is a substantially cylindrical shape in which one end in the central axis direction along the central axis C of the tubular portion 420 is open and the other end in the central axis direction is closed. The ink introduction member 710 can be inserted in and removed from the valve housing 517 from an opening of the valve housing 517 formed at one end in the central axis direction. The valve housing 517 has a retaining portion 517A of the seal member 510 and an engaging portion 517B configured to be engaged with the tubular portion 420 on one end side in the central axis direction. As illustrated in FIG. 5, the valve housing 517 is mounted in the tubular portion 420. At this time, a gap forming the replenishment flow paths 411 and 412 is formed between the valve housing 517 and the tubular portion 420. The valve housing 517 has a side surface opening portion 517C, and in the valve-open state, the replenishment flow paths 411 and 412 communicate with the introduction flow paths 711 and 712, respectively, via the side surface opening portion 517C.

The valve body 520 is disposed to be movable in the central axis direction in the valve housing 517. The valve body 520 is formed of, for example, a thermoplastic resin such as polyethylene or polypropylene.

FIG. 10 is a view illustrating a configuration of the valve body 520 according to the first embodiment. The valve body 520 has a cylindrical portion 524, a seal surface 525, and a protrusion 526.

The cylindrical portion 524 extends in the central axis direction. The shape of the cylindrical portion 524 is cylindrical. As illustrated in FIG. 5, the cylindrical portion 524 faces the inner surface of the valve housing 517. The cylindrical portion 524 is guided by the inner surface of the valve housing 517 and is slidable in the central axis direction.

The seal surface 525 is formed on an outlet-side end surface 527 positioned on the ink outlet 460 side of the cylindrical portion 524. As illustrated in FIG. 10, the seal surface 525 extends in the radial direction of the cylindrical portion 524 intersecting the central axis direction. The seal surface 525 is formed over the entire circumference of the tubular portion 420 in the circumferential direction around the central axis C. As illustrated in FIG. 6, the seal surface 525 comes into contact with a first seal portion 511, which will be described later, of the seal member 510 in the valve-closed state of the outlet valve unit 500.

The protrusion 526 is formed on the outlet-side end surface 527 on the inner side in the radial direction of the cylindrical portion 524 with respect to the seal surface 525. As illustrated in FIG. 5, the protrusion 526 is positioned on the ink outlet 460 side with respect to the seal surface 525 in the central axis direction. The protrusion 526 has a partition contact portion 526A and an inclined surface 526B. As illustrated in FIG. 8, the partition contact portion 526A is in contact with the partition 714 of the ink introduction member 710 in the valve-open state of the outlet valve unit 500. As illustrated in FIG. 10, the inclined surface 526B extends from the partition contact portion 526A toward the seal surface 525. In the present embodiment, the shape of the protrusion 526 is frustoconical, in which the cross-sectional area in the direction orthogonal to the central axis direction is larger on the side opposite from the ink outlet 460 than on the ink outlet 460 side.

As illustrated in FIG. 5, the spring member 530 biases the valve body 520 toward the ink outlet 460 side. The spring member 530 is accommodated in the valve housing 517 and is supported by the valve housing 517. The spring member 530 is formed of, for example, metal. In the present embodiment, the spring member 530 is a coil spring.

The seal member 510 is mounted inside the valve housing 517. The seal member 510 is positioned on the ink outlet 460 side with respect to the valve body 520 in the central axis direction. The shape of the seal member 510 is substantially ring-shaped. The seal member 510 is formed of, for example, an elastic rubber member or an elastomer. The seal member 510 has a through-hole 515 into which the ink introduction member 710 is inserted and removed. The through-hole 515 is formed by an inner peripheral surface of the seal member 510.

### A-4. Detailed Configuration of Valve Body

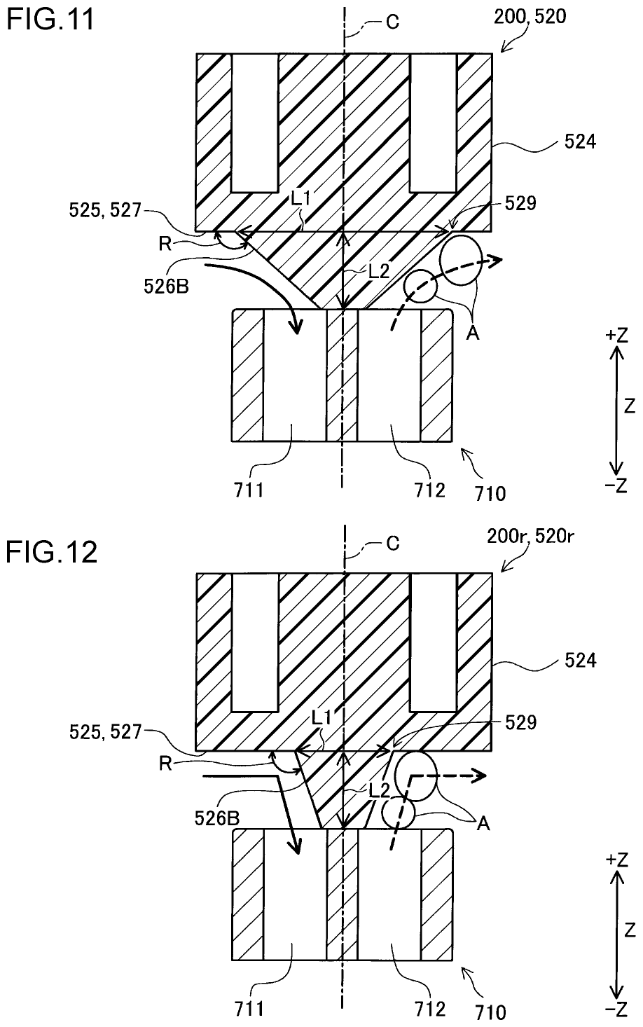

FIG. 11 is a schematic view showing the replenishment state when the ink tank 700 is replenished with the ink from the ink replenishment container 200 having the valve body 520 in which an angle R formed by the inclined surface 526B and the seal surface 525 is 110 degrees or more. FIG. 12 is a schematic view showing the replenishment state when the ink tank 700 is replenished with ink from an ink replenishment container 200r as a reference example including a valve body 520r in which the angle R formed by the inclined surface 526B and the seal surface 525 is less than 110 degrees. FIGS. 11 and 12 illustrate cross sections when a part of the configuration of the ink replenishment containers 200 and 200r and a part of the configuration of the ink introduction member 710 in the valve-open state of the outlet valve unit 500 are cut along the central axis C of the tubular portion 420. In FIGS. 11 and 12, the solid line arrows indicate the flow of the ink. The broken line arrows indicate the flow of air A.

As illustrated in FIG. 12, when the angle R formed by the inclined surface 526B and the seal surface 525 is less than 110 degrees, the air A that has formed bubbles in the ink tank 700 may stay in a corner 529 formed at the boundary between the inclined surface 526B and the seal surface 525. When the air A in the ink tank 700 stays in the corner 529, the flow of the air A from the ink tank 700 to the ink replenishment container 200r may be blocked. When the flow of the air A from the ink tank 700 to the ink replenishment container 200r is blocked, the supply of the ink from the ink replenishment container 200r to the ink tank 700 may not be started or the timing of the start of the supply of the ink may be delayed. In addition, when the flow of the air A from the ink tank 700 to the ink replenishment container 200r is blocked, the supply rate of the ink from the ink replenishment container 200r to the ink tank 700 may decrease.

On the other hand, as illustrated in FIG. 11, in the present embodiment, the angle R formed by the inclined surface 526B and the seal surface 525 is 110 degrees or more. When the angle R formed by the inclined surface 526B and the seal surface 525 is 110 degrees or more in this manner, the air A flows along the inclined surface 526B, and thus it is possible to reduce the possibility that the air A in the ink tank 700 stays in the corner 529. As a result, when the angle R formed by the inclined surface 526B and the seal surface 525 is 110 degrees or more, the air A can be smoothly circulated from the ink tank 700 to the ink replenishment container 200 as compared with the case where the angle R formed by the inclined surface 526B and the seal surface 525 is less than 110 degrees. Then, the air A flows into the container main body 300 via the second replenishment flow path 412, allowing the ink to flow out from the container main body 300 and flow into the first introduction flow path 711 via the first replenishment flow path 411, and the gas-liquid exchange is performed. In such an aspect, the supply of the ink from the ink replenishment container 200 to the ink tank 700 can be quickly started. Further, compared to a case where the angle R formed by the inclined surface 526B and the seal surface 525 is less than 110 degrees, the supply rate of the ink from the ink replenishment container 200 to the ink tank 700 can be increased. Therefore, when the angle R formed by the inclined surface 526B and the seal surface 525 is 110 degrees or more, the replenishment time of the ink can be shortened as compared with the case where the angle R formed by the inclined surface 526B and the seal surface 525 is less than 110 degrees.

The angle R formed by the inclined surface 526B and the seal surface 525 may be 110 degrees or more and 150 degrees or less. A diameter L1 of the bottom surface of the protrusion 526 may be 4.3 times or less than a height L2 of the protrusion 526. The height L2 of the protrusion 526 may be 1.5 mm or more. In this way, it is possible to more reliably reduce the possibility that the gas-liquid exchange is hindered.

### A-5. Detailed Configuration of Seal Member

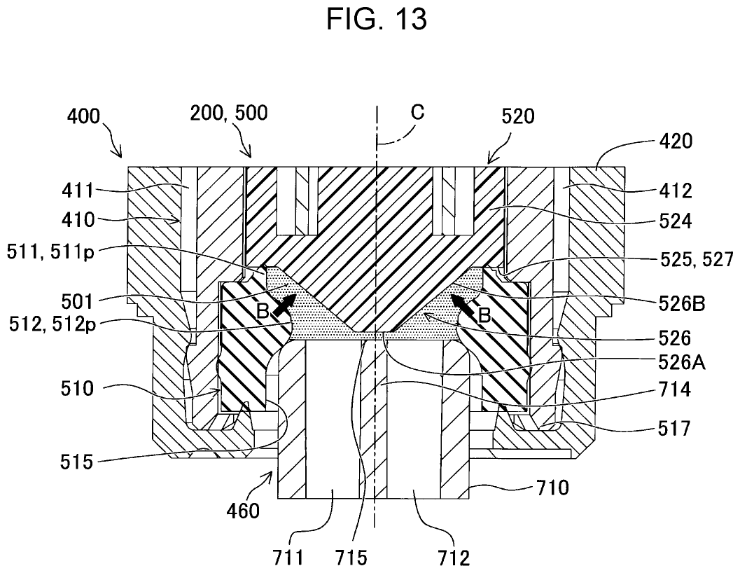

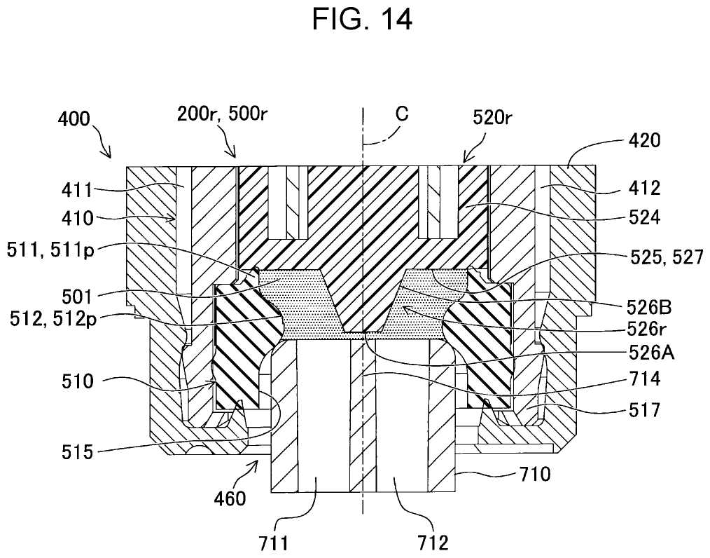

FIG. 13 is a partial sectional view of the ink replenishment container 200 and the ink tank 700 in a transition state between the valve-open state and the valve-closed state of the outlet valve unit 500. FIG. 14 is a partial sectional view of the ink replenishment container 200r and the ink tank 700 as the reference example in the transition state of an outlet valve unit 500r. In the process of the ink introduction member 710 being removed from the ink replenishment containers 200 and 200r, and the process of the ink introduction member 710 being inserted into the ink replenishment containers 200 and 200r, the outlet valve units 500 and 500r are in the transition state. FIGS. 13 and 14 illustrate cross sections when a part of the configuration of the ink replenishment containers 200 and 200r and a part of the configuration of the ink introduction members 710 in the transition state of the outlet valve units 500 and 500r are cut along the central axis C of the tubular portion 420. In FIGS. 13 and 14, the ink introduction member 710 is inserted into the tubular portion 420, but is not in contact with the partition contact portion 526A.

As illustrated in FIG. 13, in the present embodiment, the seal member 510 further includes the first seal portion 511. The first seal portion 511 switches the communication between the replenishment flow paths 411 and 412 and the introduction flow paths 711 and 712. Specifically, as illustrated in FIG. 5, in the valve-closed state of the outlet valve unit 500, the valve body 520 is biased by the spring member 530 toward the seal member 510 positioned on the ink outlet 460 side with respect to the valve body 520. The first seal portion 511 closes the through-hole 515 by being in contact with the seal surface 525 of the valve body 520 in the valve-closed state of the outlet valve unit 500 by the biasing of the spring member 530. As a result, the first seal portion 511 blocks the communication between the replenishment flow paths 411 and 412 and the introduction flow paths 711 and 712. On the other hand, as illustrated in FIG. 7, the ink introduction member 710 is inserted into the tubular portion 420 from the ink outlet 460, and the valve body 520 is pressed in a counter-biasing direction D2 opposite to a biasing direction D1 of the spring member 530. Accordingly, the first seal portion 511 is separated from the seal surface 525 of the valve body 520. As a result, a gap is formed between the first seal portion 511 and the valve body 520 in the valve-open state of the outlet valve unit 500.

As illustrated in FIG. 6, the inclined surface 526B is inclined with respect to the central axis C of the tubular portion 420 by a predetermined angle. Therefore, although not illustrated, when the seal member 510 closes the through-hole 515 by coming into contact with the inclined surface 526B of the valve body 520, the seal member 510 closes the through-hole 515 by being deformed to be crushed while spreading in the direction of the inclined surface along the inclined surface 526B. As a result, the seal member 510 is likely to creep, and the sealing property of the seal member 510 is likely to be lowered.

On the other hand, as illustrated in FIG. 13, in the present embodiment, the first seal portion 511 is formed by a first seal protrusion 511p. The first seal protrusion 511p protrudes toward the seal surface 525 of the valve body 520 along the central axis C of the tubular portion 420. As illustrated in FIG. 6, the first seal protrusion 511p is in contact with the seal surface 525 of the valve body 520 in the valve-closed state of the outlet valve unit 500. In such an aspect, the first seal portion 511 can close the through-hole 515 by coming into contact with the seal surface 525 extending in the radial direction of the cylindrical portion 524 without coming into contact with the inclined surface 526B. As a result, the sealing property of the seal member 510 can be improved as compared with a case where the through-hole 515 is closed by the seal member 510 coming into contact with the inclined surface 526B of the valve body 520.

As illustrated in FIG. 13, in the present embodiment, the seal member 510 further includes a second seal portion 512. In the valve-open state of the outlet valve unit 500, the second seal portion 512 is in contact with the ink introduction member 710. As a result, the second seal portion 512 blocks the communication between a space portion 501 and the outside of the ink outlet 460. The space portion 501 is a space defined by the valve body 520 and the seal member 510. Specifically, the space portion 501 is a space surrounded by the tip end surface 715 of the ink introduction member 710, the seal surface 525, the partition contact portion 526A, and the inclined surface 526B of the valve body 520, and a portion from the first seal portion 511 to the second seal portion 512 of the inner peripheral surface of the seal member 510.

As illustrated in FIGS. 13 and 14, regardless of the angle R formed by the inclined surface 526B and the seal surface 525, the first seal portion 511 that is in contact with the valve bodies 520 and 520r and the second seal portion 512 that is in contact with the ink introduction member 710 are separated from each other in each of the central axis direction and the radial direction. The second seal portion 512 is positioned on the ink outlet 460 side with respect to the first seal portion 511 in the central axis direction. Therefore, when the ink introduction member 710 is removed from the tubular portion 420, first, the first seal portion 511 comes into contact with the valve bodies 520 and 520r, and the communication between the replenishment flow paths 411 and 412 and the introduction flow paths 711 and 712 is blocked. After the communication between the replenishment flow paths 411 and 412 and the introduction flow paths 711 and 712 is blocked, the ink introduction member 710 is separated from the second seal portion 512 and the sealing by the second seal portion 512 is released, thereby allowing the space portion 501 to communicate with the outside of the ink outlet 460. Therefore, when the ink replenishment containers 200 and 200r are removed from the ink introduction member 710, the ink accommodated in the space portion 501 may leak from the ink outlet 460 to the outside of the ink outlet 460 and the ink may drip.

When the heights L2 of the protrusions 526 and 526r are the same, an area of the bottom surface of the protrusions 526 and 526r is large when the angle R formed by the inclined surface 526B and the seal surface 525 is 110 degrees or more, as compared with the case where the angle R formed by the inclined surface 526B and the seal surface 525 is less than 110 degrees. The term “height L2 of the protrusions 526 and 526r” refers to the height from the bottom surface of the frustoconical protrusions 526 and 526r to the partition contact portion 526A. Therefore, when the heights L2 of the protrusions 526 and 526r are the same, the volume of the protrusions 526 and 526r is large when the angle R formed by the inclined surface 526B and the seal surface 525 is 110 degrees or more, as compared with the case where the angle R formed by the inclined surface 526B and the seal surface 525 is less than 110 degrees. Therefore, when the angle R formed by the inclined surface 526B and the seal surface 525 is 110 degrees or more, the volume of the space portion 501 is smaller than that when the angle R formed by the inclined surface 526B and the seal surface 525 is less than 110 degrees. As the volume of the space portion 501 is smaller, the amount of ink accommodated in the space portion 501 can be reduced. Therefore, when the angle R formed by the inclined surface 526B and the seal surface 525 is 110 degrees or more, the following can be achieved as compared with the case where the angle R formed by the inclined surface 526B and the seal surface 525 is less than 110 degrees. In this case, it is possible to reduce the amount of ink dripping when the ink replenishment container 200 is removed from the ink introduction member 710.

Further, as illustrated in FIG. 13, in the present embodiment, the second seal portion 512 is formed by a second seal protrusion 512p. The second seal protrusion 512p protrudes toward the central axis C of the tubular portion 420. The cross-sectional shape of the second seal protrusion 512p in the central axis direction is an arc-shape. That is, the second seal protrusion 512p has a direction component B toward the inclined surface 526B of the valve body 520. In such an aspect, the volume of the space portion 501 can be reduced as compared with a case where the cross-sectional shape of the second seal protrusion 512p cut along the central axis direction is a planar shape protruding parallel to the radial direction of the cylindrical portion 524 without having the direction component B toward the inclined surface 526B of the valve body 520. As a result, the amount of ink dripping when the ink replenishment container 200 is removed from the ink introduction member 710 can be further reduced.

According to the first embodiment, the replenishment time of the ink can be shortened by setting the angle R formed by the inclined surface 526B and the seal surface 525 to 110 degrees or more.

### B. Second Embodiment

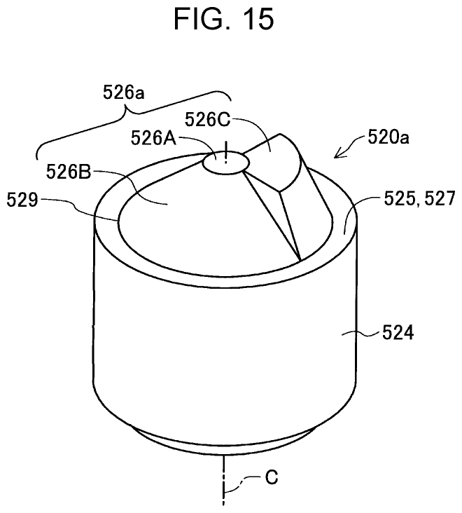

FIG. 15 is a view illustrating a configuration of a valve body 520a according to a second embodiment. In the present embodiment, the shape of the valve body 520a is different from the valve body 520 of the first embodiment. Other components are the same as those in the first embodiment unless otherwise specified. The same components as those in the first embodiment are denoted by the same reference numerals, and the description thereof will be omitted.

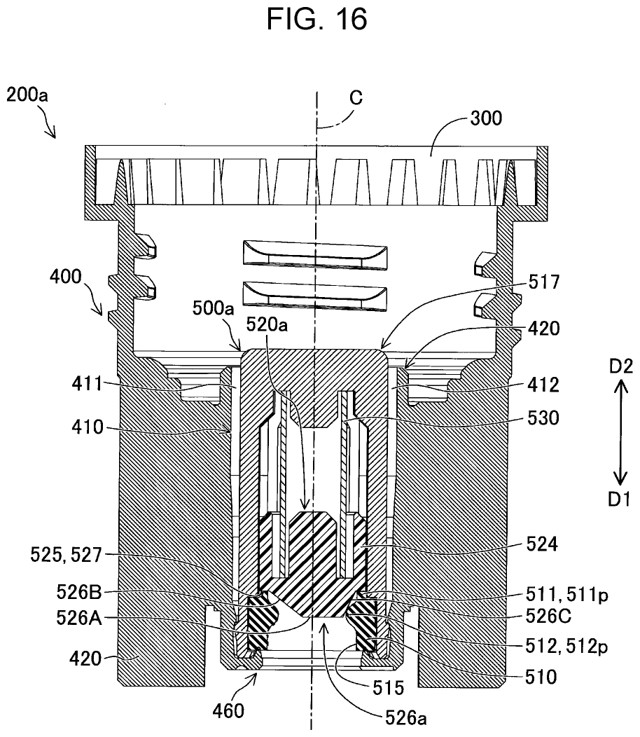

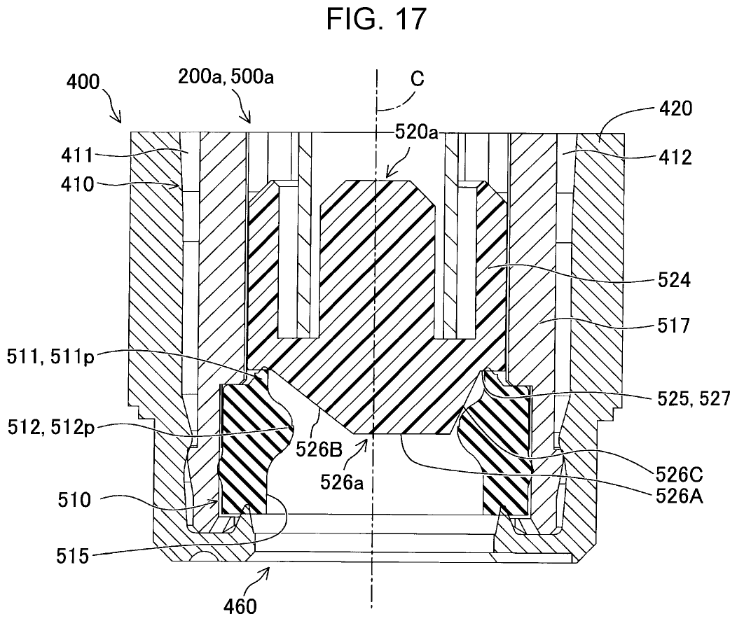

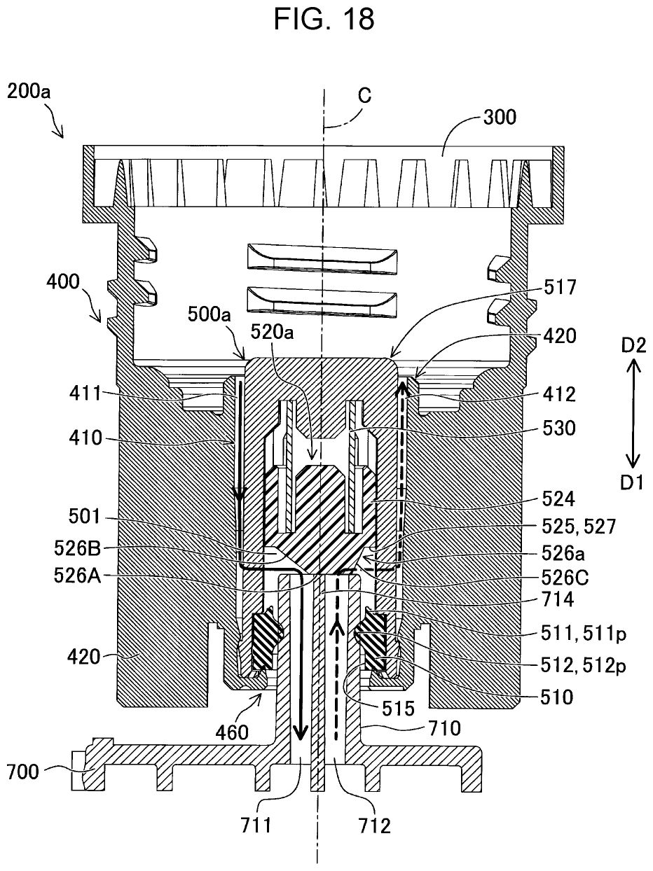

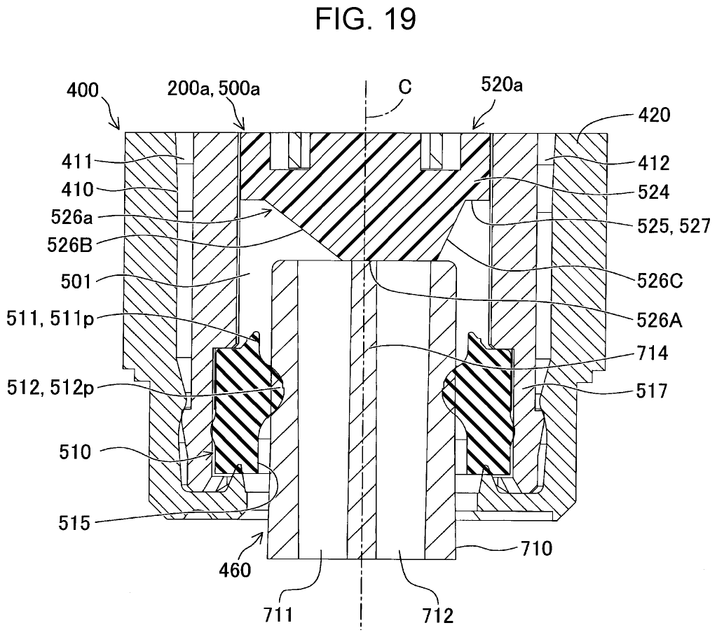

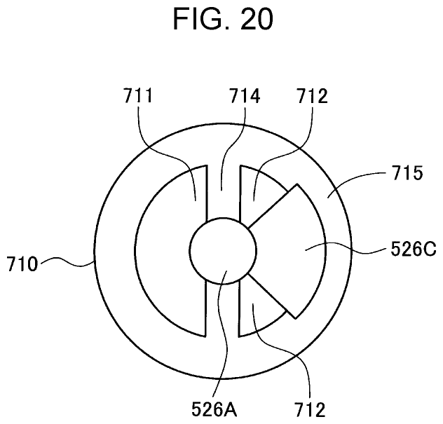

FIG. 16 is a partial sectional view of an ink replenishment container 200a of the second embodiment in the non-replenishment state. FIG. 16 shows a cross section when a part of the configuration of the ink replenishment container 200a is cut along the central axis C of the tubular portion 420. FIG. 17 is an enlarged view of a part of FIG. 16. FIG. 18 is a partial sectional view of the ink replenishment container 200a and the ink tank 700 of the second embodiment in the replenishment state. FIG. 18 shows a cross section when a part of the configuration of the ink replenishment container 200a and a part of the configuration of the ink introduction member 710 are cut along the central axis C of the tubular portion 420. FIG. 19 is an enlarged view of a part of FIG. 18. FIG. 20 is a view illustrating a contact state between a protrusion 526a of the valve body 520 and the tip end surface 715 of the ink introduction member 710.

The protrusion 526a of the valve body 520a included in an outlet valve unit 500a of the present embodiment further includes a closing portion 526C. As illustrated in FIG. 20, the closing portion 526C closes a part of the opening end surface 718 of one flow path 712 of the introduction flow paths 711 and 712 having a uniform opening end area. In the present embodiment, similar to the first embodiment, the ink introduction member 710 has two introduction flow paths 711 and 712. In FIGS. 16 to 20, a case where the closing portion 526C closes a part of the opening end surface 718 of the second introduction flow path 712 of the two introduction flow paths 711 and 712 is illustrated as an example. In the present embodiment, the closing portion 526C is formed to be continuous with the partition contact portion 526A, but in another embodiment, the closing portion 526C may be formed without being continuous with the partition contact portion 526A.

When the ink tank 700 is replenished with the ink by the gas-liquid exchange, when the two introduction flow paths 711 and 712 are equally blocked, the supply of the ink from the ink replenishment container 200a to the ink tank 700 may not be started or the timing of the start of the supply of the ink may be delayed. On the other hand, as illustrated in FIG. 20, in the present embodiment, the closing portion 526C closes a part of the opening end surface 718 of the second introduction flow path 712 such that the opening end area of the second introduction flow path 712 is smaller than the opening end area of the first introduction flow path 711. That is, the closing portion 526C closes a part of the opening end surface 718 of one introduction flow path 712 so that the opening end areas of the two introduction flow paths 711 and 712 are made non-uniform. Here, since the ink has a viscosity, the ink is less likely to flow inside the flow paths 411, 412, 711, and 712 than the air A. Therefore, among the two introduction flow paths 711 and 712, the ink flows through the introduction flow path 711 having a smaller resistance during the flow. The larger the opening end area, the smaller the resistance during the flow. Therefore, among the two introduction flow paths 711 and 712, the ink flows through the first introduction flow path 711 having a larger opening end area. Among the two introduction flow paths 711 and 712, the air A flows through the second introduction flow path 712 having a smaller opening end area. In such an aspect, it is possible to promote the determination of the flow paths 411, 412, 711, and 712 of the ink and the air A. As a result, as illustrated in FIG. 15, when the protrusion 526a has the closing portion 526C, the supply of the ink from the ink replenishment container 200a to the ink tank 700 can be started more quickly than in a case where the protrusion 526 does not have the closing portion 526C, as illustrated in FIG. 10. Therefore, when the protrusion 526a has the closing portion 526C, the replenishment time of the ink can be shortened as compared with a case where the protrusion 526 does not have the closing portion 526C.

According to the second embodiment, the replenishment time of the ink can be shortened by closing, by the closing portion 526C, a part of the opening end surface 718 of one introduction flow path 712 of the two introduction flow paths 711 and 712 having a uniform opening end area.

Further, according to the second embodiment, as illustrated in FIG. 19, when the protrusion 526a has the closing portion 526C, the volume of the space portion 501 is smaller than that when the protrusion 526 does not have the closing portion 526C, as illustrated in FIG. 8. As a result, when the protrusion 526a has the closing portion 526C, the amount of ink dripping when the ink replenishment container 200a is removed from the ink introduction member 710 can be reduced as compared with the case where the protrusion 526 does not have the closing portion 526C.

### C. Other Embodiments

### C-1. Another Embodiment 1

When the valve body 520a has the closing portion 526C, the angle R formed by the inclined surface 526B and the seal surface 525 may not be 110 degrees or more. Even in such an aspect, the replenishment time of the ink can be shortened.

### C-2. Another Embodiment 2

The ink replenishment containers 200 and 200a may have three or more replenishment flow paths 411 and 412. The ink introduction member 710 may have three or more introduction flow paths 711 and 712. In this case, the closing portion 526C may close a part of the opening end surfaces 717 and 718 of two or more introduction flow paths 711 and 712. Even in such an aspect, the replenishment time of the ink can be shortened.

### C-3. Another Embodiment 3

The closing portion 526C may close a part of the opening end surface 717 of the first introduction flow path 711. In this case, the first introduction flow path 711 is used as a flow path of the air A. The second introduction flow path 712 is used as a flow path of the ink. Even in such an aspect, the replenishment time of the ink can be shortened.

### C-4. Another Embodiment 4

In the ink replenishment containers 200 and 200a, it is not essential that the first seal portion 511 is formed by the first seal protrusion 511p. Further, it is not essential that the ink replenishment containers 200 and 200a have the second seal portion 512.

### D. Other Embodiments

The present disclosure is not limited to the above-described embodiments, and can be implemented in various configurations without departing from the concept of the present disclosure. For example, the technical features of the embodiments corresponding to the technical features of the aspects described in the summary of the disclosure can be replaced or combined as appropriate in order to solve some or all of the problems described above or to achieve some or all of the effects described above. In addition, unless the technical features are described as essential in the present specification, the technical features can be deleted as appropriate.

(1) According to an aspect of the present disclosure, there is provided an ink replenishment container. The ink replenishment container that replenishes an ink tank of a printer with ink via an ink introduction member having a plurality of flow paths partitioned by a partition, the flow paths communicating with the ink tank, the ink replenishment container includes a container main body configured to accommodate ink, an ink outlet forming portion that is coupled to the container main body and includes a tubular portion that forms an outlet on a side opposite from the container main body, and an outlet valve unit that is mounted in the ink outlet forming portion, is opened by the ink introduction member being inserted into the tubular portion from the outlet, and is closed by the ink introduction member being removed from the tubular portion, in which the outlet valve unit includes a valve body that is movably disposed in a central axis direction along a central axis of the tubular portion, a spring member that biases the valve body toward the outlet side, and a seal member that is positioned on the outlet side with respect to the valve body in the central axis direction and includes a through-hole into and from which the ink introduction member is inserted and removed, the seal member further includes a first seal portion that closes the through-hole by being in contact with the valve body in a valve-closed state of the outlet valve unit, a gap is formed between the first seal portion and the valve body in a valve-open state of the outlet valve unit, the valve body includes a cylindrical portion extending in the central axis direction, a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and a protrusion that is formed on the outlet-side end surface on an inner side with respect to the seal surface in the radial direction, the protrusion includes a partition contact portion that is positioned on the outlet side with respect to the seal surface in the central axis direction and is in contact with the partition of the ink introduction member in the valve-open state, and an inclined surface extending from the partition contact portion toward the seal surface, a cross-sectional area of the protrusion in a direction orthogonal to the central axis direction is larger on the side opposite from the outlet than on the outlet side, and an angle formed between the inclined surface and the seal surface is 110 degrees or more. According to this aspect, by setting the angle formed between the inclined surface and the seal surface to 110 degrees or more, the air flows along the inclined surface, and thus it is possible to reduce the possibility that the air stays at the corner formed at the boundary between the inclined surface and the seal surface. As a result, air can be smoothly circulated from the ink tank to the ink replenishment container. Therefore, the supply of the ink from the ink replenishment container to the ink tank can be quickly started, and the supply rate of the ink from the ink replenishment container to the ink tank can be increased. Therefore, the replenishment time of the ink can be shortened.

(2) In the above aspect, the angle formed between the inclined surface and the seal surface may be 150 degrees or less. According to this aspect, it is possible to more reliably reduce the possibility that the gas-liquid exchange is hindered. As a result, the replenishment time of the ink can be more reliably shortened.

(3) In the above aspect, the first seal portion may be formed by a first seal protrusion that protrudes toward the seal surface along the central axis, the first seal protrusion being in contact with the seal surface in the valve-closed state. According to this aspect, the first seal portion can close the through-hole by coming into contact with the seal surface without coming into contact with the inclined surface. As a result, it is possible to reduce the possibility that the sealing property by the seal member is lowered due to the creep of the seal member.

(4) In the above-described aspect, the seal member may further include a second seal portion that is in contact with the ink introduction member in the valve-open state, and the second seal portion may be formed of a second seal protrusion that protrudes toward the central axis, the second seal protrusion having an arc-shaped cross-section in the central axis direction. According to this aspect, the volume of the space portion defined by the valve body and the seal member can be reduced. As a result, the amount of ink accommodated in the space portion can be reduced. Therefore, it is possible to reduce the amount of ink dripping when the ink replenishment container is removed from the ink introduction member.

(5) In the above aspect, the protrusion may further include a closing portion that closes a part of an opening end surface of some of the plurality of flow paths of the ink introduction member having a uniform opening end area. According to this aspect, among the plurality of flow paths of the ink introduction member having a uniform opening end area, by closing a part of the opening end surface of some of the flow paths with the closing portion, it is possible to promote the determination of the flow path of the ink and the air. As a result, the supply of the ink from the ink replenishment container to the ink tank can be quickly started. Therefore, the replenishment time of the ink can be more reliably shortened.

(6) According to another aspect of the present disclosure, there is provided an ink replenishment container. The ink replenishment container that replenishes an ink tank of a printer with ink via an ink introduction member having a plurality of flow paths partitioned by a partition, the flow paths communicating with the ink tank, the ink replenishment container includes a container main body configured to accommodate ink, an ink outlet forming portion that is coupled to the container main body and includes a tubular portion that forms an outlet on a side opposite from the container main body, and an outlet valve unit that is mounted in the ink outlet forming portion, is opened by the ink introduction member being inserted into the tubular portion from the outlet, and is closed by the ink introduction member being removed from the tubular portion, in which the outlet valve unit includes a valve body that is movably disposed in a central axis direction along a central axis of the tubular portion, a spring member that biases the valve body toward the outlet side, and a seal member that is positioned on the outlet side with respect to the valve body in the central axis direction and includes a through-hole into and from which the ink introduction member is inserted and removed, the seal member further includes a first seal portion that closes the through-hole by being in contact with the valve body in a valve-closed state of the outlet valve unit, a gap is formed between the first seal portion and the valve body in a valve-open state of the outlet valve unit, the valve body includes a cylindrical portion extending in the central axis direction, a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and a protrusion that is formed on the outlet-side end surface on an inner side with respect to the seal surface in the radial direction, and the protrusion includes a partition contact portion that is positioned on the outlet side with respect to the seal surface in the central axis direction and is in contact with the partition of the ink introduction member in the valve-open state, and a closing portion that closes a part of an opening end surface of some of the plurality of flow paths of the ink introduction member having a uniform opening end area. According to this aspect, among the plurality of flow paths of the ink introduction member having a uniform opening end area, by closing a part of the opening end surface of some of the flow paths with the closing portion, it is possible to promote the determination of the flow path of the ink and the air. As a result, the supply of the ink from the ink replenishment container to the ink tank can be quickly started. Therefore, the replenishment time of the ink can be shortened.

Not all of a plurality of components of each aspect of the present disclosure described above are essential. Some of the plurality of components can be changed, deleted, or replaced with new other components as appropriate and some of limitations can be deleted in order to solve some or all of the above-described problems or to achieve some or all of the effects described in the present specification. In addition, in order to solve some or all of the above-described problems or to achieve some or all of the effects described in the present specification, some or all of technical features included in one aspect of the present disclosure described above can be combined with some or all of technical features included in another aspect of the present disclosure described above to form an independent aspect of the present disclosure.

The present disclosure can also be realized in various forms other than the ink replenishment container. For example, the present disclosure can be implemented in the form of a method for manufacturing an ink replenishment container.

What is claimed is:

1. An ink replenishment container that replenishes an ink tank of a printer with ink via an ink introduction member having a plurality of flow paths partitioned by a partition, the flow paths communicating with the ink tank, the ink replenishment container comprising:
a container main body configured to accommodate ink;
an ink outlet forming portion that is coupled to the container main body and includes a tubular portion that forms an outlet on a side opposite from the container main body; and
an outlet valve unit that is mounted in the ink outlet forming portion, is opened by the ink introduction member being inserted into the tubular portion from the outlet, and is closed by the ink introduction member being removed from the tubular portion, wherein
the outlet valve unit includes
a valve body that is movably disposed in a central axis direction along a central axis of the tubular portion,
a spring member that biases the valve body toward the outlet side, and
a seal member that is positioned on the outlet side with respect to the valve body in the central axis direction and includes a through-hole into and from which the ink introduction member is inserted and removed,
the seal member further includes a first seal portion that closes the through-hole by being in contact with the valve body in a valve-closed state of the outlet valve unit,
a gap is formed between the first seal portion and the valve body in a valve-open state of the outlet valve unit,
the valve body includes
a cylindrical portion extending in the central axis direction,
a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and
a protrusion that is formed on the outlet-side end surface on an inner side with respect to the seal surface in the radial direction,
the protrusion includes
a partition contact portion that is positioned on the outlet side with respect to the seal surface in the central axis direction and is in contact with the partition of the ink introduction member in the valve-open state, and
an inclined surface extending from the partition contact portion toward the seal surface,
a cross-sectional area of the protrusion in a direction orthogonal to the central axis direction is larger on the side opposite from the outlet than on the outlet side, and
an angle formed between the inclined surface and the seal surface is 110 degrees or more.

2. The ink replenishment container according to claim 1, wherein
the angle formed between the inclined surface and the seal surface is 150 degrees or less.

3. The ink replenishment container according to claim 1, wherein
the first seal portion is formed by a first seal protrusion that protrudes toward the seal surface along the central axis, the first seal protrusion being in contact with the seal surface in the valve-closed state.

4. The ink replenishment container according to claim 1, wherein
the seal member further includes a second seal portion that is in contact with the ink introduction member in the valve-open state, and
the second seal portion is formed by a second seal protrusion that protrudes toward the central axis, the second seal protrusion having an arc-shaped cross-section in the central axis direction.

5. The ink replenishment container according to claim 1, wherein
the protrusion further includes a closing portion that closes a part of an opening end surface of some of the plurality of flow paths of the ink introduction member having a uniform opening end area.

6. An ink replenishment container that replenishes an ink tank of a printer with ink via an ink introduction member having a plurality of flow paths partitioned by a partition, the flow paths communicating with the ink tank, the ink replenishment container comprising:
a container main body configured to accommodate ink;
an ink outlet forming portion that is coupled to the container main body and includes a tubular portion that forms an outlet on a side opposite from the container main body; and
an outlet valve unit that is mounted in the ink outlet forming portion, is opened by the ink introduction member being inserted into the tubular portion from the outlet, and is closed by the ink introduction member being removed from the tubular portion, wherein
the outlet valve unit includes
a valve body that is movably disposed in a central axis direction along a central axis of the tubular portion,
a spring member that biases the valve body toward the outlet side, and
a seal member that is positioned on the outlet side with respect to the valve body in the central axis direction and includes a through-hole into and from which the ink introduction member is inserted and removed,
the seal member further includes a first seal portion that closes the through-hole by being in contact with the valve body in a valve-closed state of the outlet valve unit,
a gap is formed between the first seal portion and the valve body in a valve-open state of the outlet valve unit,
the valve body includes
a cylindrical portion extending in the central axis direction,
a seal surface that is formed on an outlet-side end surface of the cylindrical portion positioned on the outlet side, and extends in a radial direction of the cylindrical portion intersecting the central axis direction, the seal surface being in contact with the first seal portion in the valve-closed state, and
a protrusion that is formed on the outlet-side end surface on an inner side with respect to the seal surface in the radial direction, and
the protrusion includes
a partition contact portion that is positioned on the outlet side with respect to the seal surface in the central axis direction and is in contact with the partition of the ink introduction member in the valve-open state, and
a closing portion that closes a part of an opening end surface of some of the plurality of flow paths of the ink introduction member having a uniform opening end area.
